(19) United States
(12) Patent Application Publication
(10) Pub. No.: US 2026/0197462 A1
(43) Pub. Date: Jul. 9, 2026

(54) CONDITIONAL CODING FOR LEARNING-BASED DYNAMIC POINT CLOUD CODING FRAMEWORK

(71) Applicant: InterDigital VC Holdings, Inc., Wilmington, DE (US)

(72) Inventors: Muhammad Asad Lodhi, Highland Park, NJ (US); Jiahao Pang, Plainsboro, NJ (US); Junghyun Ahn, New York, NY (US); Dong Tian, Boxborough, MA (US)

(21) Appl. No.: 19/015,188

(22) Filed: Jan. 9, 2025

(51) Int. Cl. H04N 19/14; H04N 19/169; H04N 19/172; H04N 19/597

(52) U.S. Cl. CPC H04N 19/14; H04N 19/172; H04N 19/1883; H04N 19/597

(57) ABSTRACT

Some embodiments of a method may include: decoding a motion feature from a motion bitstream; determining a predicted feature based on the decoded motion feature and a reference point cloud frame; decoding a first feature representing an occupancy of a child level; obtaining a second feature based on the decoded first feature and the predicted feature; and determining a tree voxel occupancy status of the child level using the second feature.

### INCORPORATION BY REFERENCE

The present application incorporates by reference in their entirety the following applications: U.S. Non-Provisional patent application Ser. No. 18/784,466, entitled “END-TO-END LEARNING-BASED DYNAMIC POINT CLOUD FRAMEWORK” and filed Jul. 25, 2024 (“'466 application”).

### BACKGROUND

The present application is related to point clouds.

### SUMMARY

A first example method in accordance with some embodiments may include: decoding a motion feature from a motion bitstream; determining a predicted feature based on the decoded motion feature and a reference point cloud frame; decoding a first feature representing an occupancy of a child level; obtaining a second feature based on the decoded first feature and the predicted feature; and determining a tree voxel occupancy status of the child level using the second feature.

Some embodiments of the first example method may further include obtaining the motion bitstream.

For some embodiments of the first example method, obtaining the second feature includes adding the first feature and the predicted feature.

For some embodiments of the first example method, obtaining the second feature includes alternating between the first feature and the predicted feature to use as the second feature.

For some embodiments of the first example method, the first feature corresponds to an intra feature and the predicted feature corresponds to an inter feature.

Some embodiments of the first example method may further include passing the obtained second feature through a convolutional neural network (CNN).

For some embodiments of the first example method, the output of the CNN includes a reconstructed feature.

Some embodiments of the first example method may further include passing the obtained second feature through at least one of a Multi-Layer Perceptron (MLP) block, an Inception ResNet (IRN) block, or a transformer block.

Some embodiments of the first example method may further include generating a reconstructed feature using the first feature and the predicted feature.

A first example apparatus in accordance with some embodiments may include: a processor; and a memory storing instructions operative, when executed by the processor, to cause the apparatus to: decode a motion feature from a motion bitstream; determine a predicted feature based on the decoded motion feature and a reference point cloud frame; decode a first feature representing an occupancy of a child level; obtain a second feature based on the decoded first feature and the predicted feature; and determine a tree voxel occupancy status of the child level using the second feature.

A second example method in accordance with some embodiments may include: determining a motion feature from a current point cloud and at least one of one or more reference point cloud frames; determining a predicted feature based on the motion feature; encoding the motion feature into a bitstream; determining a first feature representing an occupancy of a child level; obtaining a second feature based on the first feature and the predicted feature; and encoding the second feature into a bitstream.

Some embodiments of the second example method may further include obtaining the current point cloud geometry based on the one or more reference point cloud frames.

For some embodiments of the second example method, obtaining the second feature includes adding the first feature and the predicted feature.

For some embodiments of the second example method, obtaining the second feature includes alternating between the first feature and the predicted feature to use as the second feature.

For some embodiments of the second example method, the first feature corresponds to an intra feature and the predicted feature corresponds to an inter feature.

Some embodiments of the second example method may further include passing the obtained second feature through a convolutional neural network (CNN).

Some embodiments of the second example method may further include: conditionally encoding an output of the CNN, wherein the conditionally encoded output includes a lossy feature; and inserting the conditionally encoded output into a bitstream.

Some embodiments of the second example method may further include passing the obtained second feature through at least one of a Multi-Layer Perceptron (MLP) block, an Inception ResNet (IRN) block, or a transformer block.

Some embodiments of the second example method may further include: using the first feature and the predicted feature to generate a feature to be encoded; and encoding into the bitstream the feature to be encoded.

For some embodiments of the second example method, determining the first feature includes: obtaining a feature map; obtaining coordinates of a lossy reconstruction of a parent level; and performing a feature interpolation to generate the first feature, wherein the feature map and the coordinates of the lossy reconstruction of the parent level are used as inputs into the feature interpolation.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example process for a hierarchical feature coding branch with a predicted feature according to some embodiments.

FIG. 3 is a process diagram illustrating an example process for an octree coding branch with a predicted feature according to some embodiments.

FIG. 4 is a process diagram illustrating an example conditional encoder (CE) according to some embodiments.

FIG. 5 is a process diagram illustrating an example conditional decoder (CD) according to some embodiments.

FIG. 6 is a process diagram illustrating an example lossy conditional encoder (CE′) according to some embodiments.

FIG. 7 is a process diagram illustrating an example lossy additive conditional encoder (CE′) according to some embodiments.

FIG. 8 is a process diagram illustrating an example additive conditional decoder (CD) according to some embodiments.

FIG. 9 is a process diagram illustrating an example lossy switching conditional encoder (CE′) according to some embodiments.

FIG. 10 is a process diagram illustrating an example switching conditional decoder (CD) according to some embodiments.

FIG. 11 is a flowchart illustrating an example decoding process according to some embodiments.

FIG. 12 is a flowchart illustrating an example encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

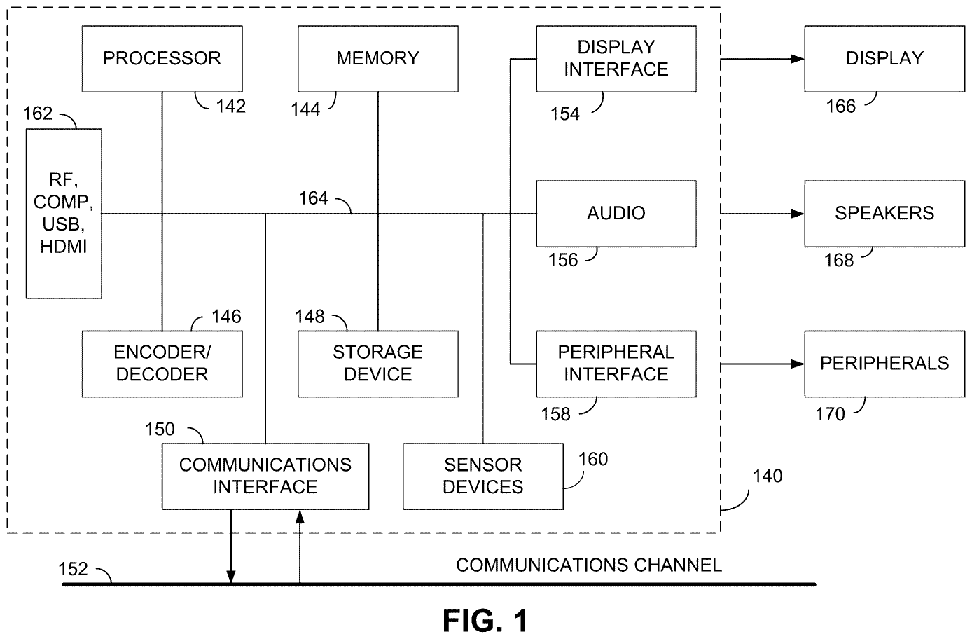

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation and understanding of input signals, such as point clouds.

As understood, the present application, for some embodiments, presents a new conditional coding design on top of the base conditional coding.

Point cloud data is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when the storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer as opposed to standard TV in which the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects, like statues or buildings, are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data include discrete samples of the surfaces of objects or scenes. A huge number of points may be used to fully represent the real world with point samples. For instance, a typical VR immersive scene may contain millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds may be classified into two categories: geometry coding and attribute coding.

Examples of learning-based point cloud geometry compression techniques include deep octree coding and end-to-end feature-based geometry coding. With deep octree coding, neural network-based models are utilized to estimate occupancy probabilities. Such estimated probabilities are then used to help the arithmetic coder to encode or decode a binary flag indicating whether a child octree voxel is occupied or empty.

This application discusses the problem of dynamic point cloud compression, which benefits both feature-based geometry coding as well as octree coding.

Point cloud compression is a problem in many practical applications, such as autonomous driving and AR/VR, among other applications. This application discusses dynamic point cloud compression based on deep learning and sparse tensor processing, which compresses an input point cloud given a reference point cloud. This application discusses conditional coding architectures understood to be new. This application provides a more efficient way to code a dynamic point cloud in a tree structure by providing conditional coding architectures that may reduce the complexity and may make the system more rate efficient.

A dynamic point cloud compression method may differ from literature work. The present application, for some embodiments, unifies the motion estimation and motion compensation of the lossy (feature-based) and lossless (octree-based) coding.

For some embodiments, a full point cloud compression framework may include two branches: the inter-branch and the main branch. The inter-coding branch produces the predicted feature F_{pred}. An overview of the main branch is presented below.

### Feature-Based Coding in the Full Compression Framework

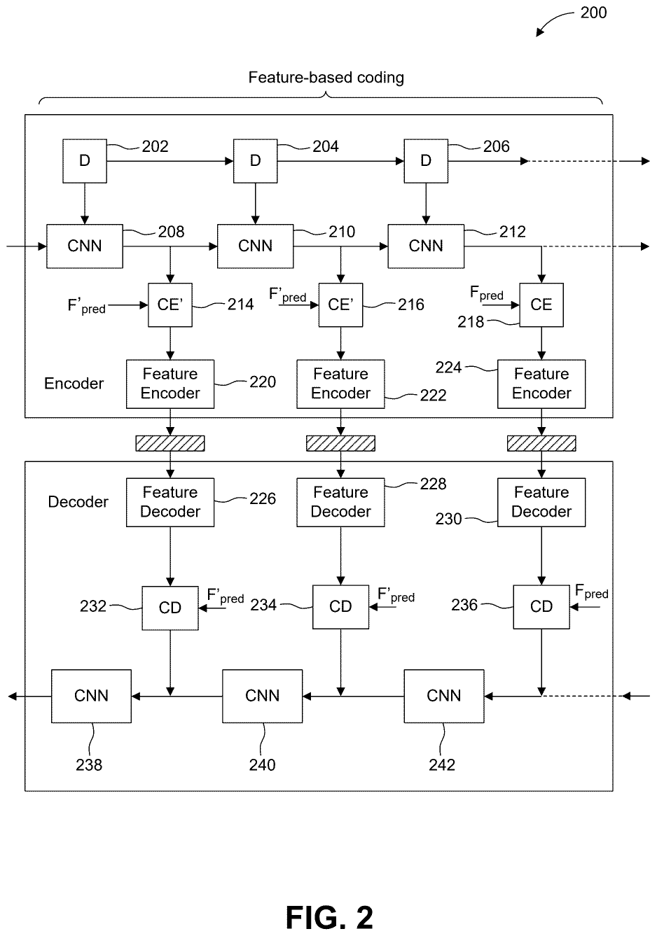

FIG. 2 is a process diagram illustrating an example process for a hierarchical feature coding branch with a predicted feature according to some embodiments. FIG. 2 depicts the feature coding branch 200 of the main coding branch. A feature-based coding method is shown in FIG. 2.

The encoder is shown in the top part of FIG. 2. During feature extraction and aggregation, the resolution of the input is typically downsampled via downsampling blocks 202, 204, 206. The encoder has a few CNN-like neural network blocks 208, 210, 212. They extract and aggregate a feature map from the input, for example, point cloud frames. When the predicted feature F_{pred} (or F′_{pred}) is available, both F_{pred} (or F′_{pred}) and the extracted feature F are inputted to the conditional encoder (CE or CE′) 214, 216, 218 for feature encoding. Finally, the extracted feature is sent to a Feature Encoder (FE) block 220, 222, 224 to output a bitstream.

The decoder is shown in the bottom part of FIG. 2. The bitstream is inputted to a series of Feature Decoder blocks 226, 228, 230. Both F_{pred} (or F′_{pred}) and the decoded feature are inputted into the conditional decoder (CD) 232, 234, 236 for decoding. The decoder has a few CNN-like neural network blocks 238, 240, 242. They correspond to the few CNN-like neural network blocks 208, 210, 212 in the encoder. Instead of performing downsampling/pooling, the CNN-like neural network blocks 238, 240, 242 reconstruct the input, e.g., point cloud, via upsampling/unpooling.

The CNN blocks may be enhanced or replaced by MLP or some other neural network blocks, such as Inception ResNet (IRN) or transformer blocks.

### Octree-Based Coding in Full Compression Framework

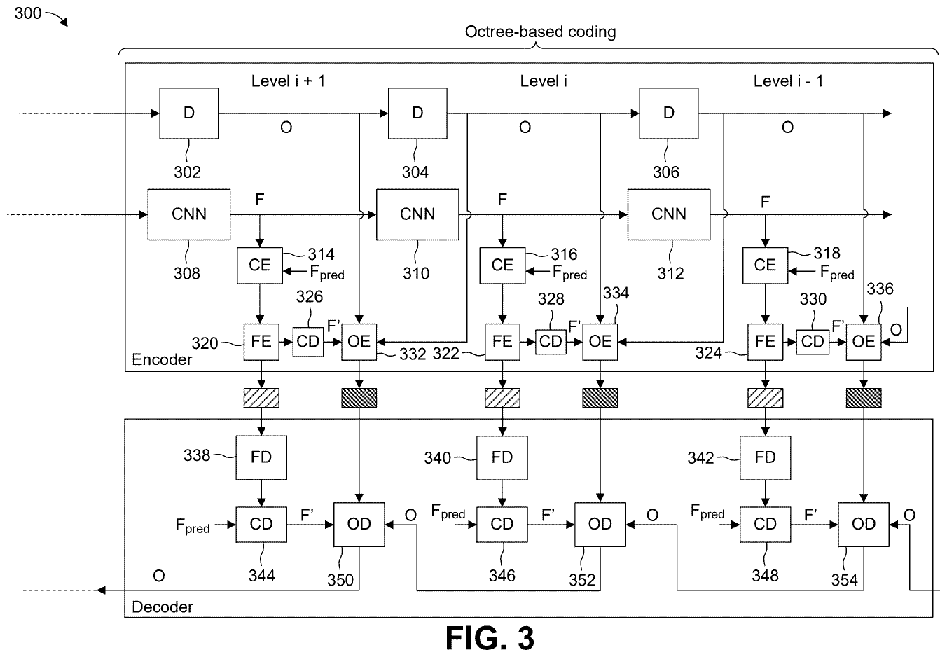

FIG. 3 is a process diagram illustrating an example process for an octree coding branch with a predicted feature according to some embodiments. FIG. 3 depicts the octree coding branch 300 of the main coding branch. Octree-based coding, in conjunction with feature-based coding, is shown in FIG. 3.

The encoder is shown in the top part of FIG. 3. First, a few downsampling “D” blocks 302, 304, 306 at the top are used during encoding to downsample the point cloud. The features are extracted by the CNNs 308, 310, 312, which are subsequently encoded into bitstreams. As before, when the predicted feature F_{pred} is available, both F_{pred} and the extracted feature F are inputted into the conditional encoder (CE) 314, 316, 318 for feature encoding (FE) 320, 322, 324 and for generating the feature F′ via the conditional decoder (CD) blocks 326, 328, 330 for occupancy encoding.

The direction to perform feature extraction by CNNs is from left to right. The direction indicates that the feature extraction is based on a finer level of octree. Note all voxels in the current level may also be used since the encoder has access to the whole octree. The earlier method of FIG. 2, which does not transmit a feature bitstream, cannot use any voxels not yet decoded for feature extraction.

On decoder side, the features are decoded by feature decoder (FD) blocks 338, 340, 342. The decoded feature is used to assist the octree encoding (OE) blocks 332, 334, 336 and octree decoding (OD) blocks 350, 352, 354. On the decoder side, both F_{pred}, and the decoded feature are inputted to the conditional decoder (CD) 344, 346, 348 for decoding F′ and subsequent occupancy decoding.

In some embodiments, the feature outputted for use at level i is generated with every voxel that is occupied at level i. In addition, features are also generated for non-occupied voxels if its parent voxel is occupied. These features are later used by octree encoding (OE) blocks 332, 334, 336 and octree decoding (OD) blocks 350, 352, 354 to compute the occupancy probabilities.

### Conditional Encoder and Conditional Decoder

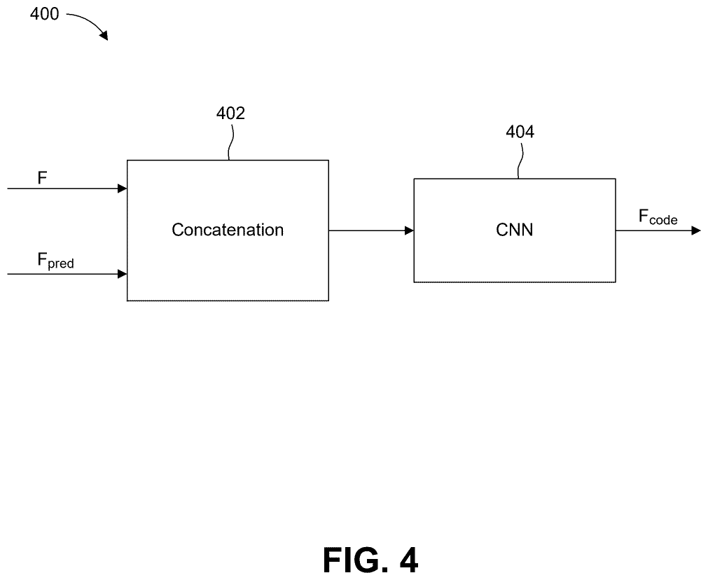

FIG. 4 is a process diagram illustrating an example conditional encoder (CE) according to some embodiments. The earlier conditional encoders of FIGS. 2 and 3 may have a structure 400 as shown in FIG. 4. The inputs to the conditional encoder (FIG. 4) are the current feature extracted from the current point cloud and a predicted feature obtained from the reference point cloud(s). These inputs are used to perform a concatenation 402. The concatenated feature is inputted to a CNN block 404 to output the feature to be encoded.

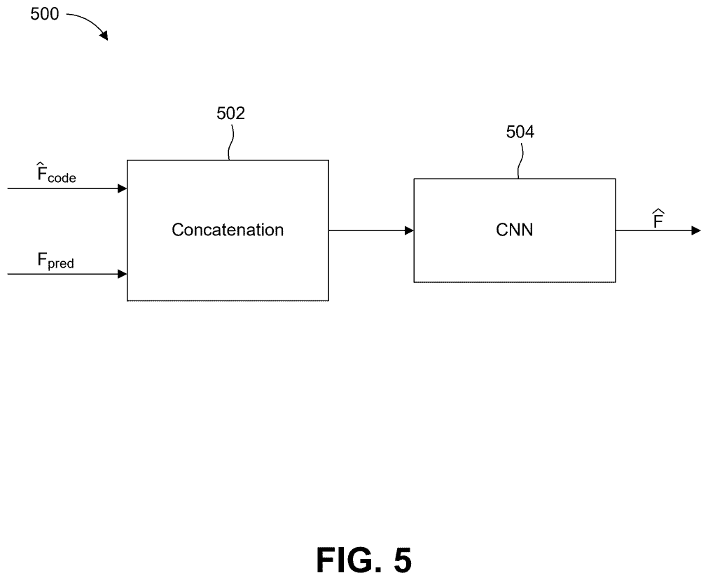

FIG. 5 is a process diagram illustrating an example conditional decoder (CD) according to some embodiments. The earlier conditional decoders of FIGS. 2 and 3 may have a structure 500 as shown in FIG. 5. The inputs to the conditional decoder (FIG. 5) are the reconstructed feature and the predicted feature. These inputs are used to perform a concatenation 502. The concatenated feature is inputted to a CNN block 504 to output the reconstructed current feature.

### Conditional Encoding Architectures

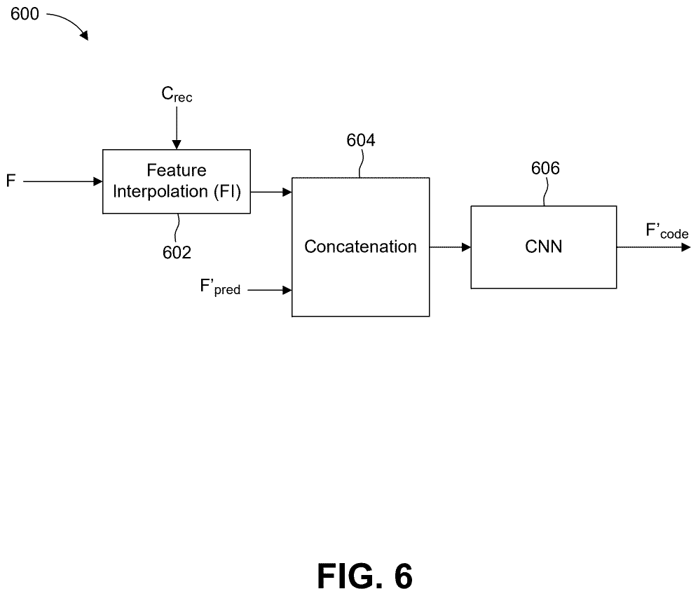

FIG. 6 is a process diagram illustrating an example lossy conditional encoder (CE′) according to some embodiments. A feature map (F) and the coordinates of the lossy reconstruction from the parent level (C_{rec}) are inputted into a feature interpolation (FI) block 602. The feature interpolation (FI) block 602 interpolates the current feature map to match the lossy coordinates. The output of the feature interpolation block 602 (an intra feature) and the inter predicted feature

$$( {F}_{pred}^{′} )$$

are inputted to the concatenation block 604 to be concatenated. The concatenated output is processed by a CNN block 606 to output the lossy feature

$$( {F}_{code}^{′} )$$

to be conditionally encoded. The rest of the pipeline remains the same.

### Additive Conditional Coding

Described below are some architectures for the conditional encoder and conditional decoder that may enhance the performance of the overall compression system.

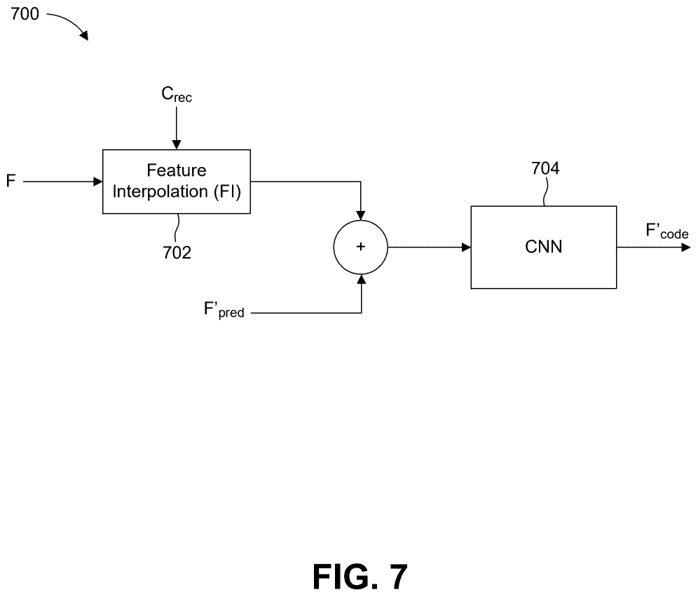

FIG. 7 is a process diagram illustrating an example lossy additive conditional encoder (CE′) according to some embodiments. FIG. 7 shows an example additive design architecture 700 of a conditional encoder. A feature map (F) and the coordinates of the lossy reconstruction from the parent level (C_{rec}) are inputted into a feature interpolation (FI) block 702. The feature interpolation (FI) block 702 interpolates the current feature map to match the lossy coordinates. The output of the feature interpolation block 702 (an intra feature) and the inter predicted feature

$$( {F}_{pred}^{′} )$$

are added together. The added features are passed through a CNN block 704 to generate the lossy feature

$$( {F}_{code}^{′} )$$

to be conditionally-encoded.

With this design, the motivation is to use the inter predicted feature as a refinement on top of the intra feature, whenever an inter feature is available. This design has the benefit of a reduced complexity because there is no concatenation of features. Compared to the example in FIG. 6, the CNN-like block 704 for feature aggregation has fewer dimensions because the input feature dimension is smaller.

For some embodiments, the elements shown in FIG. 7 may be used in place of one or more of the CE′ blocks 214, 216, 218 of FIG. 2. The feature interpolation (FI) block 702 and the CNN block 704 may be inside one or more of the CE′ blocks 214, 216, 218 shown in FIG. 2 for some embodiments.

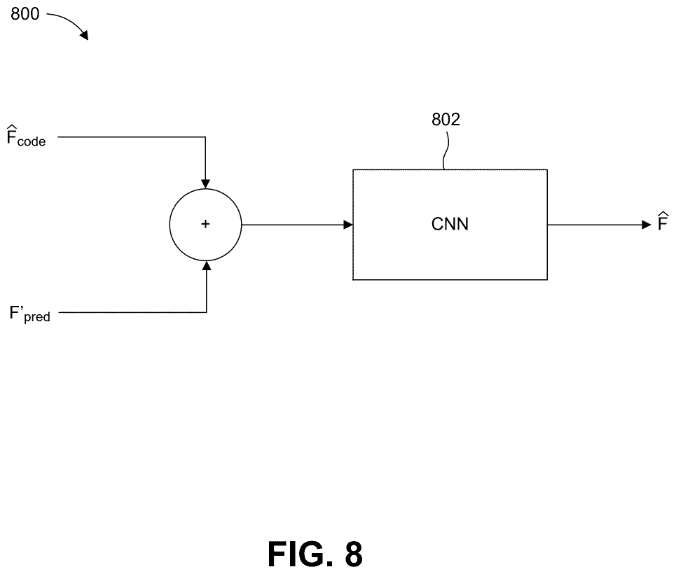

FIG. 8 is a process diagram illustrating an example additive conditional decoder (CD) according to some embodiments. FIG. 8 shows an example additive design architecture 800 of a conditional decoder. The inputs to the conditional decoder are the reconstructed feature (\hat{F}_{code}) and the predicted feature

$$( {F}_{pred}^{′} ) .$$

These inputs are added together. The added features are passed through a CNN block 802 to generate the reconstructed feature (\hat{F}).

For some embodiments, the elements shown in FIG. 8 may be used in place of one or more of the CD blocks 232, 234, 236 of FIG. 2. The CNN block 802 may be inside one or more of the CD blocks 232, 234, 236 shown in FIG. 2 for some embodiments. The CNN block 802 is used to update the features after addition, whereas the CNN blocks 238, 240, 242 perform upsampling, which is mentioned above in the description of FIG. 2.

### Switch Conditional Coding

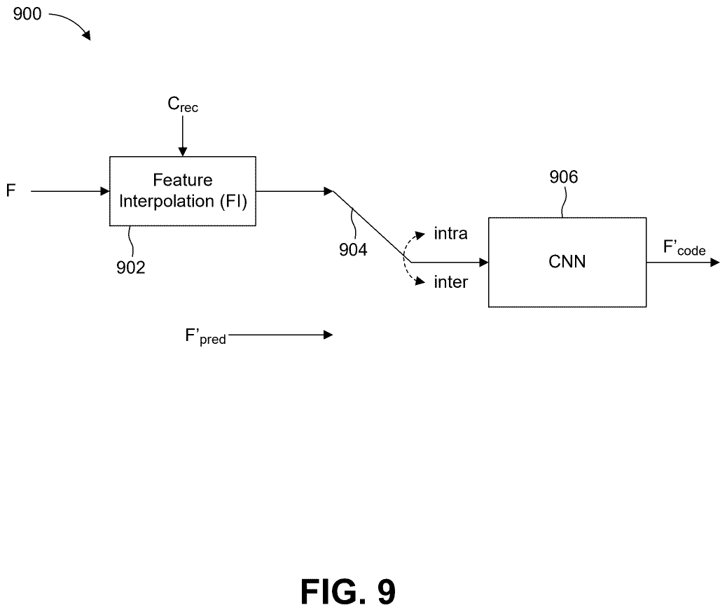

FIG. 9 is a process diagram illustrating an example lossy switching conditional encoder (CE′) according to some embodiments. For some embodiments, a switch mechanism 904 may be used in the conditional coding design. Its structure for a conditional encoder 900 is provided in FIG. 9. A feature map (F) and the coordinates of the lossy reconstruction from the parent level (C_{rec}) are inputted into a feature interpolation (FI) block 902. The feature interpolation (FI) block 902 interpolates the current feature map to match the lossy coordinates and outputs an intra feature. In contrast to the previous feature concatenation of intra and inter features (see FIG. 6), the switch mechanism 904 shown in FIG. 9 switches between the intra and inter features to use only one of them at a time. The chosen feature is passed through a CNN block 906 to generate the lossy feature (F′_{code}) to be conditionally-encoded.

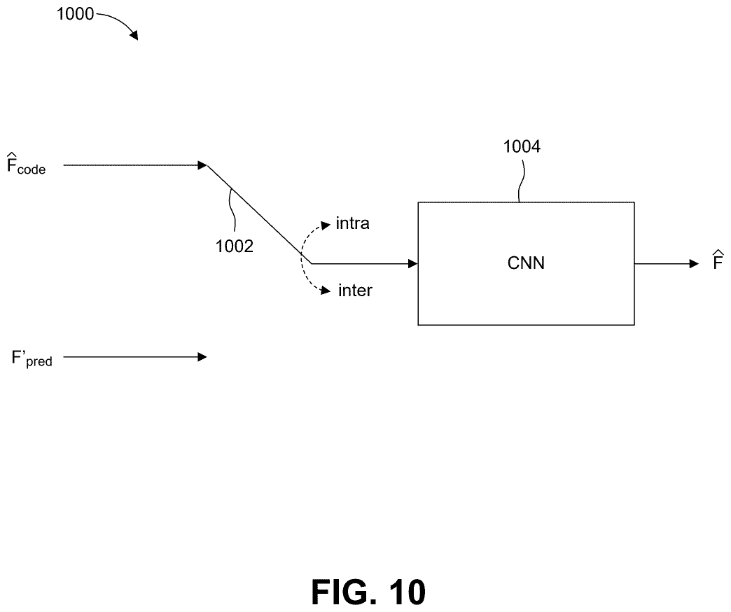

FIG. 10 is a process diagram illustrating an example switching conditional decoder (CD) according to some embodiments. For some embodiments, a switch mechanism 1002 may be used in the conditional decoding design. Its structure for a conditional decoder 1000 is provided in FIG. 10. The inputs to the conditional decoder are the reconstructed feature (\hat{F}_{code}) and the predicted feature

$$( {F}_{pred}^{′} ) .$$

In contrast to the previous concatenation of these inputs (see FIG. 5), the design shown in FIG. 10 switches between the reconstructed feature (\hat{F}_{code}) and the predicted feature

$$( {F}_{pred}^{′} )$$

to use only one of them at a time. The design of the decoder with a switch follows a similar motivation as the encoder. The chosen feature is passed through a CNN block 1004 to generate the reconstructed feature (\hat{F}).

With the designs shown in FIGS. 9 and 10, the motivation is to use the inter feature only when an inter frame is available. This design may be beneficial when the motion between the frames is very small/negligible, and the reference frame feature may provide very relevant information about the current frame. In such a case, the feature from the current frame at the current level does not need to be encoded into the bitstream for some embodiments. Moreover, like additive conditional coding, the complexity is also reduced.

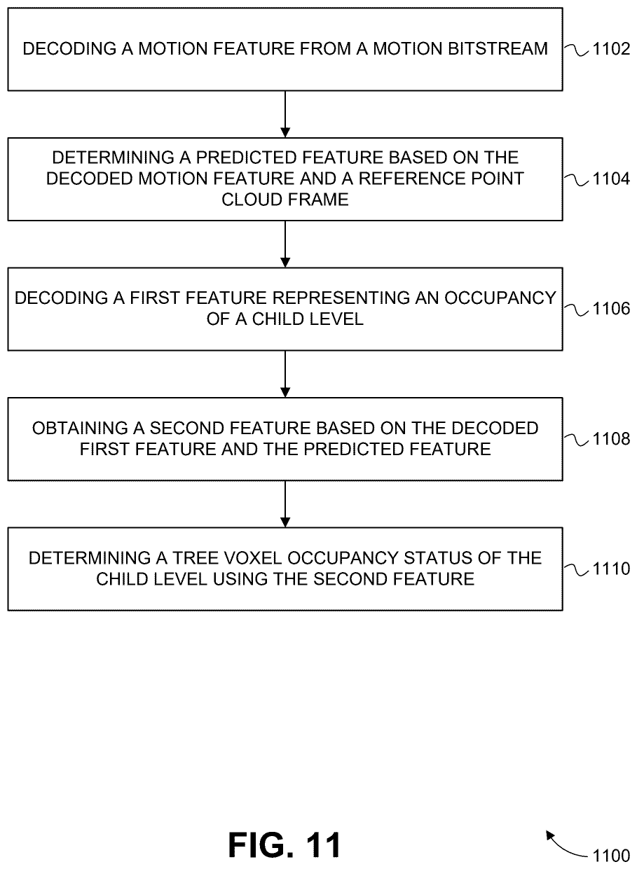

FIG. 11 is a flowchart illustrating an example decoding process according to some embodiments. For some embodiments, an example process 1100 may include decoding 1102 a motion feature from a motion bitstream. For some embodiments, the example process 1100 may further include determining 1104 a predicted feature based on the decoded motion feature and a reference point cloud frame. For some embodiments, the example process 1100 may further include decoding 1106 a first feature representing an occupancy of a child level. For some embodiments, the example process 1100 may further include obtaining 1108 a second feature based on the decoded first feature and the predicted feature. For some embodiments, the example process 1100 may further include determining 1110 a tree voxel occupancy status of the child level using the second feature.

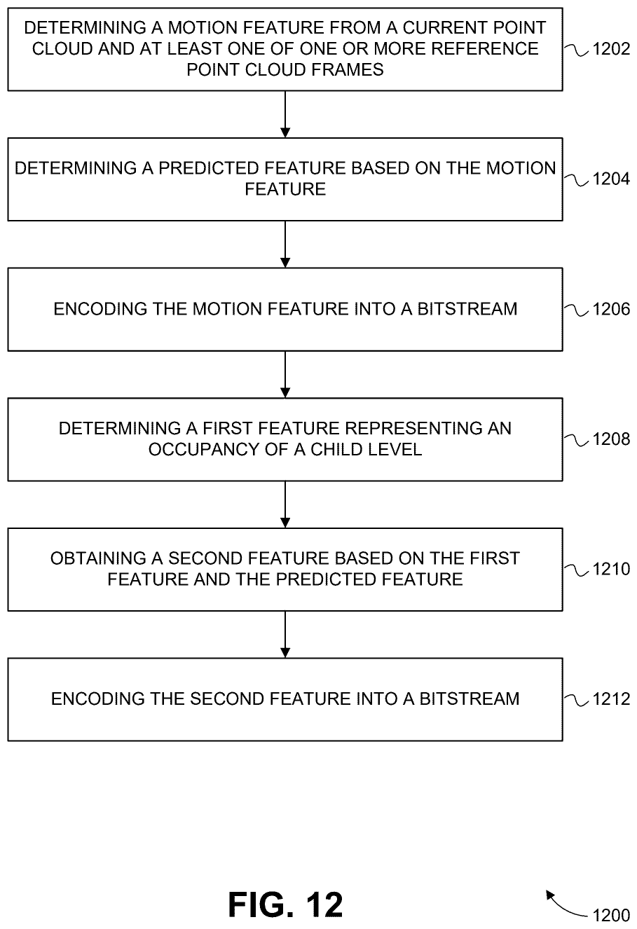

FIG. 12 is a flowchart illustrating an example encoding process according to some embodiments. For some embodiments, an example process 1200 may include determining 1202 a motion feature from a current point cloud and at least one of one or more reference point cloud frames. For some embodiments, the example process 1200 may further include determining 1204 a predicted feature based on the motion feature. For some embodiments, the example process 1200 may further include encoding 1206 the motion feature into a bitstream. For some embodiments, the example process 1200 may further include determining 1208 a first feature representing an occupancy of a child level. For some embodiments, the example process 1200 may further include obtaining 1210 a second feature based on the first feature and the predicted feature. For some embodiments, the example process 1200 may further include encoding 1212 the second feature into a bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: decoding a motion feature from a motion bitstream; determining a predicted feature based on the decoded motion feature and a reference point cloud frame; decoding a first feature representing an occupancy of a child level; obtaining a second feature based on the decoded first feature and the predicted feature; and determining a tree voxel occupancy status of the child level using the second feature.

Some embodiments of the first example method may further include obtaining the motion bitstream.

For some embodiments of the first example method, obtaining the second feature includes adding the first feature and the predicted feature.

For some embodiments of the first example method, obtaining the second feature includes alternating between the first feature and the predicted feature to use as the second feature.

For some embodiments of the first example method, the first feature corresponds to an intra feature and the predicted feature corresponds to an inter feature.

Some embodiments of the first example method may further include passing the obtained second feature through a convolutional neural network (CNN).

For some embodiments of the first example method, the output of the CNN includes a reconstructed feature.

Some embodiments of the first example method may further include passing the obtained second feature through at least one of a Multi-Layer Perceptron (MLP) block, an Inception ResNet (IRN) block, or a transformer block.

Some embodiments of the first example method may further include generating a reconstructed feature using the first feature and the predicted feature.

A first example apparatus in accordance with some embodiments may include: a processor; and a memory storing instructions operative, when executed by the processor, to cause the apparatus to: decode a motion feature from a motion bitstream; determine a predicted feature based on the decoded motion feature and a reference point cloud frame; decode a first feature representing an occupancy of a child level; obtain a second feature based on the decoded first feature and the predicted feature; and determine a tree voxel occupancy status of the child level using the second feature.

A second example method in accordance with some embodiments may include: determining a motion feature from a current point cloud and at least one of one or more reference point cloud frames; determining a predicted feature based on the motion feature; encoding the motion feature into a bitstream; determining a first feature representing an occupancy of a child level; obtaining a second feature based on the first feature and the predicted feature; and encoding the second feature into a bitstream.

Some embodiments of the second example method may further include obtaining the current point cloud geometry based on the one or more reference point cloud frames.

For some embodiments of the second example method, obtaining the second feature includes adding the first feature and the predicted feature.

For some embodiments of the second example method, obtaining the second feature includes alternating between the first feature and the predicted feature to use as the second feature.

For some embodiments of the second example method, the first feature corresponds to an intra feature and the predicted feature corresponds to an inter feature.

Some embodiments of the second example method may further include passing the obtained second feature through a convolutional neural network (CNN).

Some embodiments of the second example method may further include: conditionally encoding an output of the CNN, wherein the conditionally encoded output includes a lossy feature; and inserting the conditionally encoded output into a bitstream.

Some embodiments of the second example method may further include passing the obtained second feature through at least one of a Multi-Layer Perceptron (MLP) block, an Inception ResNet (IRN) block, or a transformer block.

Some embodiments of the second example method may further include: using the first feature and the predicted feature to generate a feature to be encoded; and encoding into the bitstream the feature to be encoded.

For some embodiments of the second example method, determining the first feature includes: obtaining a feature map; obtaining coordinates of a lossy reconstruction of a parent level; and performing a feature interpolation to generate the first feature, wherein the feature map and the coordinates of the lossy reconstruction of the parent level are used as inputs into the feature interpolation.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
decoding a motion feature from a motion bitstream;
determining a predicted feature based on the decoded motion feature and a reference point cloud frame;
decoding a first feature representing an occupancy of a child level;
obtaining a second feature based on the decoded first feature and the predicted feature; and
determining a tree voxel occupancy status of the child level using the second feature.

2. The method of claim 1, further comprising obtaining the motion bitstream.

3. The method of claim 1, wherein obtaining the second feature comprises adding the first feature and the predicted feature.

4. The method of claim 1, wherein obtaining the second feature comprises alternating between the first feature and the predicted feature to use as the second feature.

5. The method of claim 4, wherein the first feature corresponds to an intra feature and the predicted feature corresponds to an inter feature.

6. The method of claim 1, further comprising passing the obtained second feature through a convolutional neural network (CNN).

7. The method of claim 6, wherein the output of the CNN comprises a reconstructed feature.

8. The method of claim 1, further comprising passing the obtained second feature through at least one of a Multi-Layer Perceptron (MLP) block, an Inception ResNet (IRN) block, or a transformer block.

9. The method of claim 1, further comprising generating a reconstructed feature using the first feature and the predicted feature.

10. An apparatus comprising:
a processor; and
a memory storing instructions operative, when executed by the processor, to cause the apparatus to:
decode a motion feature from a motion bitstream;
determine a predicted feature based on the decoded motion feature and a reference point cloud frame;
decode a first feature representing an occupancy of a child level;
obtain a second feature based on the decoded first feature and the predicted feature; and
determine a tree voxel occupancy status of the child level using the second feature.

11. A method comprising:
determining a motion feature from a current point cloud and at least one of one or more reference point cloud frames;
determining a predicted feature based on the motion feature;
encoding the motion feature into a bitstream;
determining a first feature representing an occupancy of a child level;
obtaining a second feature based on the first feature and the predicted feature; and
encoding the second feature into a bitstream.

12. The method of claim 11, further comprising obtaining the current point cloud geometry based on the one or more reference point cloud frames.

13. The method of claim 11, wherein obtaining the second feature comprises adding the first feature and the predicted feature.

14. The method of claim 11, wherein obtaining the second feature comprises alternating between the first feature and the predicted feature to use as the second feature.

15. The method of claim 14, wherein the first feature corresponds to an intra feature and the predicted feature corresponds to an inter feature.

16. The method of claim 11, further comprising passing the obtained second feature through a convolutional neural network (CNN).

17. The method of claim 16, further comprising:
conditionally encoding an output of the CNN,
wherein the conditionally encoded output comprises a lossy feature; and
inserting the conditionally encoded output into a bitstream.

18. The method of claim 11, further comprising passing the obtained second feature through at least one of a Multi-Layer Perceptron (MLP) block, an Inception ResNet (IRN) block, or a transformer block.

19. The method of claim 11, further comprising:
using the first feature and the predicted feature to generate a feature to be encoded; and
encoding into the bitstream the feature to be encoded.

20. The method of claim 11, wherein determining the first feature comprises:
obtaining a feature map;
obtaining coordinates of a lossy reconstruction of a parent level; and
performing a feature interpolation to generate the first feature,
wherein the feature map and the coordinates of the lossy reconstruction of the parent level are used as inputs into the feature interpolation.
